(19) United States
(12) Patent Application Publication
(10) Pub. No.: US 2026/0328372 A1
(43) Pub. Date: Oct. 22, 2026

(54) DOWNLIGHT HAVING SPRING-LOADED QUICK-RELEASE STRUCTURE

(71) Applicant: Wenxing Bi, Guangzhou (CN)

(72) Inventor: Wenxing Bi, Guangzhou (CN)

(21) Appl. No.: 19/704,202

(22) Filed: Jun. 10, 2026

(30) Foreign Application Priority Data
Aug. 1, 2025 (CN) 202521633702.3

(51) Int. Cl. F21V 17/16; F21S 8/02; F21V 7/24; F21V 13/04; F21V 21/04

(52) U.S. Cl. CPC F21V 17/164; F21S 8/026; F21V 7/24; F21V 13/04; F21V 17/162; F21V 21/047

(57) ABSTRACT

A downlight having a spring-loaded quick-release structure. The downlight includes a spring-loaded quick-release structure, where the spring-loaded quick-release structure includes an inner ring and an outer ring; when the outer ring and inner ring are assembled, a positioning member on a sleeve of the inner ring abuts against an annular track on an inner wall of the outer ring; and when the outer ring and inner ring are disassembled, the positioning member moves in a direction away from the annular track under the action of a spring, such that the positioning member moves away from the annular track.

### CROSS-REFERENCE TO RELATED APPLICATIONS

The present application is a Continuation in part of Chinese Patent Application No. 202521633702.3, filed on Aug. 1, 2025.

### TECHNICAL FIELD

Embodiments of the present disclosure relate to the technical field of lamps, and in particular to a downlight having a spring-loaded quick-release structure.

### BACKGROUND

Lamps are daily necessities. Generally, a lamp needs to be connected and fixed to a power cord, such that an external power source can supply power to a light source inside the lamp.

### SUMMARY

Embodiments of the present disclosure provide a downlight having a spring-loaded quick-release structure, which allows for replacement of the downlight without removing the entire lamp and enables all-angle rotation of the downlight. The downlight includes a spring-loaded quick-release structure, a snap ring, and a lighting assembly, the spring-loaded quick-release structure including:
an outer ring provided with an annular track on an inner wall of the outer ring; and
an inner ring detachably disposed within the outer ring, where the inner ring is formed with at least one mounting hole, and a limiting assembly is provided within the mounting hole; and the limiting assembly includes a sleeve, a spring, and a positioning member, the sleeve being disposed within the mounting hole, one end of the sleeve being formed with an opening, the spring being disposed within the sleeve, one end of the spring being connected to the other end of the sleeve, the other end of the spring being connected to one end of the positioning member, and the other end of the positioning member being capable of protruding from the opening of the sleeve;
where when the outer ring and the inner ring are assembled, the other end of the positioning member on the sleeve abuts against the annular track; when a pulling force is applied to separate the inner ring from the outer ring, the positioning member is pressed radially inward against a biasing force of the spring and disengages from the annular track; and
the lighting assembly, the snap ring, the inner ring, and the outer ring are sequentially nested and mounted from inside to outside.

It should be understood that the above general description and the following detailed description are merely exemplary and illustrative, and should not limit the scope of protection of the present disclosure.

### BRIEF DESCRIPTION OF THE DRAWINGS

The foregoing and other objectives, features and advantages of the present disclosure will become more apparent from the more detailed description of the exemplary implementations of the present disclosure with reference to the accompanying drawings. In the exemplary implementations of the present disclosure, like components are generally denoted by like reference signs.

FIG. 1 is an exploded view of a downlight according to an embodiment of the present disclosure;

FIG. 2 is another exploded view of the downlight according to an embodiment of the present disclosure;

FIG. 3 is another exploded view of the downlight according to an embodiment of the present disclosure;

FIG. 4 is a cross-sectional structural schematic diagram of the downlight according to an embodiment of the present disclosure; and

FIG. 5 is a structural schematic diagram of a limiting assembly according to an embodiment of the present disclosure.

Reference signs: 1. Outer ring; 101. Mounting member; 102. Annular track; 2. Inner ring; 3. Mounting hole; 4. Limiting assembly; 401. Spring; 4011. One end of spring; 4012. Other end of spring; 402. sleeve; 4021. One end of sleeve; 4022. Other end of sleeve; 4023. Opening; 403. Positioning member; 4031. One end of positioning member; 4032. Other end of positioning member; 404. First through hole; 5. Fixing member; 6. Middle ring; 601. Second through hole; 7. Snap ring; 701. Elastic snap-fit fastener; 8. Lighting assembly; 801. Heat sink; 802. Lamp cup; 803. Light source board; 804. Lens; 805. Reflective paper.

### DESCRIPTION OF EMBODIMENTS

Implementations of the present disclosure are described in more detail below with reference to the accompanying drawings. Although the implementations of the present disclosure are shown in the accompanying drawings, it should be understood that the present disclosure can be implemented in various forms and should not be limited by the implementations set forth herein. Rather, these implementations are provided for a more thorough and complete understanding of the present disclosure, and for fully conveying the scope of the present disclosure to those skilled in the art.

Terms used in the embodiments of the present disclosure are merely for the purpose of describing specific embodiments, but are not intended to limit the present disclosure. Singular forms “a/an” and “the” used in the embodiments of the present disclosure and the appended claims are also intended to include plural forms, unless otherwise clearly indicated in the context. It should also be understood that the term “and/or” as used herein refers to and includes any or all possible combinations of one or more of the associated listed items.

It should be understood that although the terms “first”, “second”, etc. may be used in the embodiments of the present disclosure to describe various information, such information should not be limited to these terms. These terms are merely used to distinguish items of information of the same type from each other. For example, first information could also be referred to as second information, and similarly, second information could also be referred to as first information, without departing from the scope of the embodiments of the present disclosure. Thus, the features defined with “first” and “second” may explicitly or implicitly include one or more features. In the description of the embodiments of the present disclosure, the phrase “a plurality of” means two or more, unless otherwise explicitly and specifically defined.

In related art, the removal and replacement of a downlight usually require removing the entire lamp, which is not only complicated to operate, but also easily causes damage to the lamp itself and an installation base. For example, repeated removal and installation will lead to deformation of the lamp and wear of mounting points, thus affecting the aesthetics and service life of the lamp. In addition, the existing downlights have a relatively limited angle adjustment function, and can usually only be finely adjusted via snap points and cannot achieve 360° free rotation, which limits the flexible adjustment of lighting direction.

In view of the above problems, embodiments of the present disclosure provide a downlight having a spring-loaded quick-release structure, which allows for replacement of the downlight without removing the entire lamp and enables all-angle rotation of the downlight, thereby improving the practicality.

The technical solution of the embodiments of the present disclosure will be described in detail below with reference to the accompanying drawings.

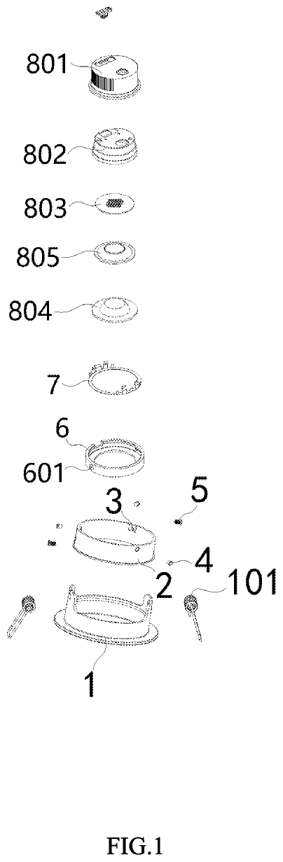

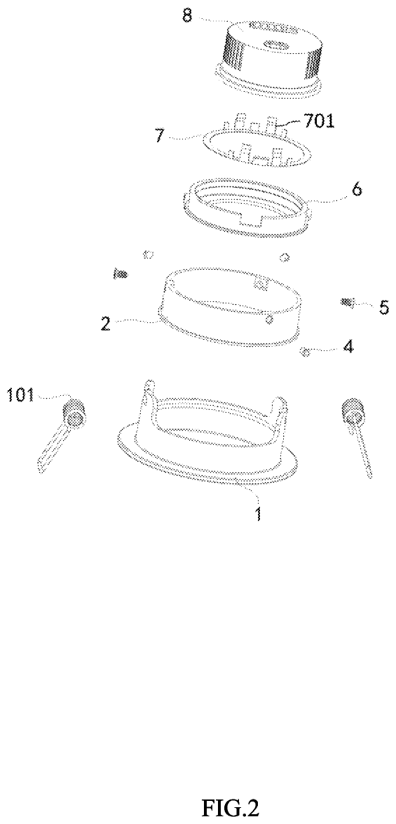

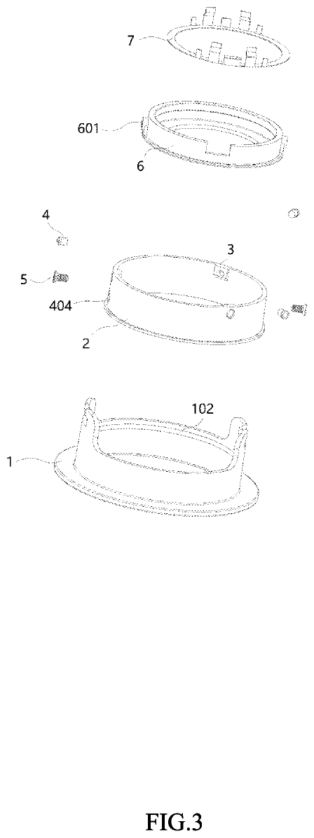

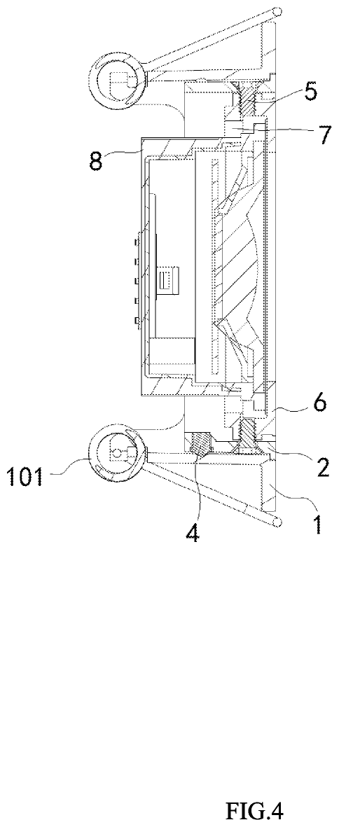

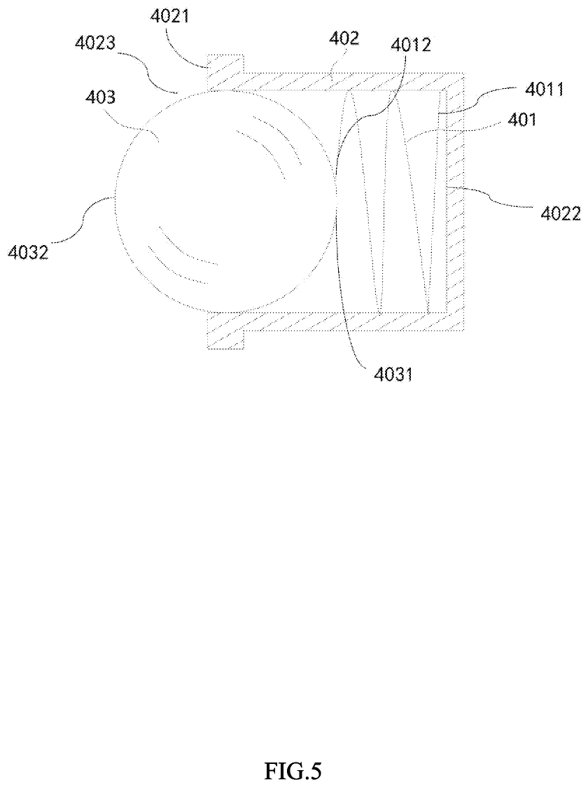

Referring to FIGS. 1 to 5, the embodiments of the present disclosure provide a downlight having a spring-loaded quick-release structure. The downlight includes a spring-loaded quick-release structure, a snap ring, and a lighting assembly, where the spring-loaded quick-release structure includes:
an outer ring 1 provided with an annular track 102 on an inner wall of the outer ring 1; and an inner ring 2 detachably disposed within outer ring 1, where the inner ring 2 is formed with at least one mounting hole 3, and a limiting assembly 4 is provided within the mounting hole 3; the limiting assembly 4 includes a sleeve 402, a spring 401, and a positioning member 403, the sleeve 402 being disposed within the mounting hole 3, one end 4021 of the sleeve being formed with an opening 4023, the spring 401 being disposed within the sleeve 402, one end 4011 of the spring being connected to the other end 4022 of the sleeve, the other end 4012 of the spring being connected to one end 4031 of the positioning member, and the other end 4032 of the positioning member being capable of protruding from the opening of the sleeve 402; when the outer ring 1 and the inner ring 2 are assembled, the positioning member 403 on the sleeve 402 abuts against an inner wall of the annular track 102; and when the outer ring 1 and the inner ring 2 are disassembled, the positioning member 403 moves in a direction away from the annular track 102 under the action of the spring 401, such that the positioning member 403 moves away from the annular track 102;
where when the outer ring and the inner ring are assembled, the other end of the positioning member on the sleeve abuts against the annular track; when a pulling force is applied to separate the inner ring from the outer ring, the positioning member is pressed radially inward against a biasing force of the spring and disengages from the annular track; and
the lighting assembly, the snap ring, the inner ring, and the outer ring are sequentially nested and mounted from inside to outside.

Specifically, the annular track 102 may be of a groove structure around the inner wall of the outer ring 1, specifically a continuous annular groove, for accommodating the positioning member 403. The mounting hole 3 refers to a through hole running through the wall of the inner ring 2, specifically a cylindrical channel, for accommodating the limiting assembly 4. The limiting assembly 4 includes a sleeve 402, a spring 401, and a positioning member 403. The sleeve 402 refers to a tubular component mounted within the mounting hole 3, specifically a metal sleeve or a plastic sleeve, for constraining a movement trajectory of the spring 401. The spring 401 may be a helical compression spring for providing a reset driving force for the positioning member 403. The positioning member 403 refers to a contact-type positioning component, specifically a metal ball.

Specifically, when the outer ring 1 and the inner ring 2 are assembled, the positioning member 403 compresses, under the action of an external force, the spring 401 to enter the interior of the sleeve 402, and when the positioning member 403 moves to a position corresponding to the annular track 102, the spring 401 releases elastic force to push the positioning member 403 into the annular track 102, thereby forming a stable mechanical connection. During disassembly, an axial tensile force is applied, the positioning member 403 slides along an inclined surface of the annular track 102 to generate a radial displacement, the spring 401 is compressed and contracted to make the positioning member 403 retract into an inner cavity of the sleeve 402, so as to separate the inner ring 2 and the outer ring 1. In this way, through the combined action of the spring 401 and the positioning member 403, the inner ring 2 and the outer ring 1 can be quickly disassembled, and then the light source can be removed more quickly, so that there is no need to remove the entire downlight from a ceiling and then replace the downlight.

Further, the inner ring 2 and the outer ring 1 may be manufactured by an integral molding process. The inner ring 2 and the outer ring 1 may be made of resin, plastic, etc., and the outer ring 1 may also be made of a metal such as iron or aluminum, which will not be limited herein. Further, the limiting assembly 4 may be mounted into the mounting hole 3 by another process after the inner ring 2 is manufactured. Alternatively, the limiting assembly 4 may be manufactured together with the inner ring 2 by an integral molding process.

Further, the inner ring 2 (with the mounting portion 4 having not yet been provided within the inner ring 2) may be manufactured as a whole, and then the mounting hole 3 may be formed in the inner ring 2.

Specifically, a diameter of the inner ring 2 is less than a diameter of the outer ring 1, such that the inner ring 2 can be mounted within the outer ring 1.

Specifically, when the positioning member 403 abuts within the annular track 102, the stable match between the inner ring 2 and the outer ring 1 may be achieved, and by rotating the inner ring 2, the positioning member 403 can move within the annular track 102 of the outer ring 1 to allow for the inner ring 2 to rotate better, enabling subsequent all-angle rotation irradiation of the lighting assembly 8 under the drive of the inner ring 2.

In a possible implementation, a plurality of mounting holes 3 are evenly distributed in a circumferential direction of the inner ring 2.

Specifically, the even distribution in the circumferential direction refers to being circumferentially arranged at equal intervals on the annular structure of the inner ring 2. For example, mounting holes 3 are provided along the circumference of the inner ring 2 at fixed angular intervals. A limiting assembly 4 is provided within each mounting hole 3. A plurality of mounting holes 3 may be provided, and the number can be set according to actual needs, which will not be limited herein.

Specifically, with the plurality of mounting holes 3 being evenly distributed along the circumference of the inner ring 2, the springs 401 in the limiting assemblies 4 within the mounting holes 3 can synchronously generate elastic deformation, so as to enable the positioning members 403 to evenly contact the inner wall of the annular track 102 when the outer ring 1 and the inner ring 2 are assembled. Such a layout enables balanced distribution of the contact force between the inner ring 2 and the outer ring 1 in the circumferential direction, so as to avoid structural deformation caused by excessive local stress. When disassembly is required, a user can apply force evenly to make the plurality of positioning members 403 synchronously disengage from the annular track 102, thereby reducing the force required for a single-point operation.

In a possible implementation, the plurality of mounting holes 3 are symmetrically arranged in the inner ring 2.

Specifically, the symmetrical arrangement may be referred to forming a mirror distribution based on a central axis in the circumferential direction of the inner ring 2, for example, employing four groups of mounting holes 3 arranged at 90-degree intervals. When a disassembly force is applied, the springs 401 in the symmetrically distributed limiting assemblies 4 deform simultaneously to cause the positioning members 403 to synchronously disengage from the annular track 102 of the outer ring 1. Such a symmetrical layout allows for a disassembly operation without requiring a specific angle of force, and applying a tensile force in any direction can trigger a synchronous action of the symmetrically positioned limiting assemblies 4. During an assembly process, the symmetrically arranged positioning members 403 can form multi-point contact with the annular track 102 of the outer ring 1 simultaneously, so as to avoid an eccentric load phenomenon caused by single-sided contact.

In a possible implementation, the positioning member 403 is spherical in shape, and the positioning member 403 is slidable within the annular track 102.

Specifically, the positioning member 403 being spherical in shape refers to the positioning member 403 being of a spherical structure in appearance. Such a spherical structure allows for the positioning member 403 to slide better within the annular track 102, so as to reduce the frictional resistance with the inner wall of the annular track 102. The annular track 102 may be a sliding groove. When the inner ring 2 and the outer ring 1 are assembled, the spherical positioning member 403 is embedded into the sliding groove of the annular track 102, and the positioning member 403 is maintained in contact with the sliding groove under an elastic force of the spring 401. When the relative angle between the inner ring 2 and the outer ring 1 needs to be adjusted, the inner ring 2 can rotate around the axis of the outer ring 1, and then the spherical positioning member 403 rolls or slides along the sliding groove, thereby achieving multi-angle adjustment. During a disassembly process, the spring 401 is deformed under compression to cause the positioning member 403 to disengage from the sliding groove, and the inner ring 2 can be directly pulled out.

In a possible implementation, a diameter of the positioning member 403 is not greater than a diameter of the opening of the sleeve 402.

Specifically, when the diameter of the positioning member 403 is equal to or slightly smaller than the diameter of the opening of the sleeve 402, the positioning member 403 can freely extend or retract along the axis of the sleeve 402 under the action of the spring 401. In an assembled state, the spring 401 is compressed to cause the positioning member 403 to partially protrude from the opening of the sleeve 402 and abut against the inner wall of the annular track, and then a clearance is present between the positioning member 403 and an edge of the opening of the sleeve 402, so as to avoid jamming caused by dimensional interference. During disassembly, the spring 401 rebounds to cause the positioning member 403 to completely retract into the interior of the sleeve 402, and an outer surface of the positioning member 403 remains in a non-contact state with an inner wall of the opening of the sleeve 402, thereby ensuring the smoothness of the disengagement action.

In a possible implementation, a fixing member 5 is further included, the inner ring 2 is formed with a first through hole 404, and the fixing member 5 can be inserted into the first through hole 404.

Specifically, the fixing member 5 refers to a fastening part configured to connect the inner ring 2 with other assemblies, and may be a screw, a pin, or a snap-fit structure. The first through hole 404 refers to a hole running through a surface of the inner ring 2, specifically a circular, square or polygonal hole structure, and functions to provide an insertion path for the fixing member 5 to achieve a positioning function. Through the cooperation of the fixing member 5 and the through hole, the inner ring 2 can be tightly connected to other components. The fixing member 5 may be a 10-15 mm self-tapping screw with a diameter that matches the through hole.

Specifically, the inner ring 2 is detachably connected to the fixing member 5 via the first through hole 404. During the assembly process, the fixing member 5 passes through the first through hole 404 of the inner ring 2 and is fixed to an external assembly. For example, when the inner ring 2 needs to be connected to the middle ring 6, the fixing member 5 can be inserted into their through holes to form a constraint. During disassembly, disconnection can be achieved simply by pulling the fixing member 5 out of the through holes.

In a possible implementation, the middle ring 6 is formed with a second through hole 601 that matches the first through hole 404, and the fixing member 5 can be inserted into the first through hole 404 and the second through hole 601 to enable the inner ring 2 and the middle ring 6 to be fixedly mounted.

Specifically, the second through hole 601 refers to a hole structure running through a surface of the middle ring 6, and is positioned and sized completely corresponding to the first through hole 404 of the inner ring 2, for example, a circular hole with a diameter ranging from 2 to 5 mm, which is formed by machining. During the assembly process, the first through hole 404 of the inner ring 2 is positioned to align with the second through hole 601 of the middle ring 6 by a rotation or translation operation, and subsequently the fixing member 5 is inserted into their through holes. The insertion of the fixing member 5 creates a rigid connection between the inner ring 2 and the middle ring 6 to avoid relative displacement.

In a possible implementation, at least one mounting member 101 is provided on the outer ring 1.

Specifically, the mounting member 101 refers to an assembly for fixing or connecting the outer ring 1 to other external structures, and is, for example, a spring clip. The mounting member 101 can provide support between the outer ring 1 and an external support structure to prevent the outer ring 1 from shifting due to uneven stress after assembly, and enable the downlight, which is formed by means of the outer ring 1, to be embedded and mounted into the ceiling. For example, when the mounting member 101 is a snap-fit structure, a protruding portion of the snap-fit fastener can be embedded into a mounting hole 3 reserved in the ceiling, such that a fixing force is generated by elastic deformation; and when disassembly is required, unlocking can be achieved by pressing a release end of the snap-fit fastener, so as to enable the outer ring 1 to be quickly mounted or removed without using auxiliary tools.

The detachable structure in the embodiments of the present disclosure is mainly for use in recessed lamps such as downlights, spotlights, and ceiling lights. Specifically, the main body portion of the lamp is mounted and fixed to the inner ring 2, and the rotation of the inner ring 2 enables the main body portion of the lamp to rotate relative to the outer ring 1 at a rotation angle that enables all-angle rotation.

In the downlight having a spring-loaded quick-release structure according to an embodiment of the present disclosure, the spring-loaded quick-release structure includes: an outer ring 1 provided with an annular track 102 on an inner wall of the outer ring 1; and an inner ring 2 detachably disposed within outer ring 1, where the inner ring 2 is formed with at least one mounting hole 3, and a limiting assembly 4 is provided within the mounting hole 3; the limiting assembly 4 includes a sleeve 402, a spring 401, and a positioning member 403, the sleeve 402 being disposed within the mounting hole 3, one side of the sleeve 402 being formed with an opening, the spring 401 being disposed within the sleeve 402, one end of the spring 401 being connected to the bottom inside the sleeve 402, the other end of the spring 401 being connected to the positioning member 403, and the positioning member 403 being capable of protruding from the opening of the sleeve 402; when the outer ring 1 and the inner ring 2 are assembled, the positioning member 403 on the sleeve 402 abuts against an inner wall of the annular track 102; and when the outer ring 1 and the inner ring 2 are disassembled, the positioning member 403 moves in a direction away from the annular track 102 under the action of the spring 401, such that the positioning member 403 moves away from the annular track 102. This allows for replacement of the downlight without removing the entire lamp, and enables all-angle rotation of the downlight, thereby improving the practicality.

Specifically, the snap ring 7 refers to an annular component for fixing the lighting assembly 8, and may be specifically a plastic member having an elastic snap-fit fastener. The lighting assembly 8 refers to an illumination module including a light source, and may be specifically formed by a heat sink 801, a lamp cup 802, a light source board 803, and a lens 804.

Specifically, the lighting assembly 8 is fixed to the innermost layer by means of the snap ring 7, the snap ring 7 is connected to the middle ring 6 by means of the elastic snap-fit fastener 701, the middle ring 6 is connected to the outer ring 1 by means of a screw or a clamping member, and the inner ring 2 fits with the annular track 102 of the outer ring 1 by means of the positioning member 403 to form a detachable structure. During assembly, the lighting assembly 8 is first embedded into the snap ring 7, the snap ring 7 is then snapped into the middle ring 6 to form a fixed connection, the middle ring 6 is connected to the inner ring 2 by means of the fixing member 5, and the inner ring 2 is connected to the outer ring 1 via the mounting hole 3, thereby forming a stable structure nested layer by layer. During disassembly, the lighting assembly 8 is separated from the outer ring 1 simply by releasing the limiting fit between the inner ring 2 and the outer ring 1, and then other components are separated layer by layer, making it more convenient to remove the lighting assembly 8. In the related art, it is necessary to remove the outer ring 1 from the ceiling and then separate the lighting assembly 8, which makes the operation too cumbersome and easily causes damage to the ceiling, thus reducing the service life of the lamp.

In a possible implementation, the lighting assembly 8 includes a heat sink 801, a lamp cup 802, a light source board 803, and a lens 804. The lamp cup 802 is mounted at a lower end of the heat sink 801, the light source board 803 is disposed within the lamp cup 802, and the lens 804 is located at a front end of the light source board 803.

Specifically, a switch may be provided at an upper end of the heat sink 801 for adjusting color temperature of the lighting assembly 8. The heat sink 801 may be a metal component for conducting and dissipating the heat generated by the light source board 803. The lamp cup 802 refers to a cup-shaped container for accommodating the light source board 803, for example, an aluminum housing with its inner wall coated with a reflective material, which reflects light to improve the light efficiency utilization rate. The light source board 803 is a circuit board that carries light-emitting elements, and can use a highly thermally conductive material to reduce thermal resistance. The lens 804 is an optical element for controlling light distribution, for example, a Fresnel lens 804 formed by injection molding of polycarbonate, which can optimize curvature to control a beam angle. The lamp cup 802 is fixed to a bottom open end of the heat sink 801 in a threaded manner or in a snap-fit manner, forming a sealed cavity. The light source board 803 is bonded to an inner bottom surface of the lamp cup 802 by means of a thermally conductive adhesive layer to ensure heat transfer to the heat sink 801. The lens 804 is embedded at a front end opening of the lamp cup 802 via an annular slot, and maintains a preset distance from the light source board 803 to form a collimated optical path.

In a possible implementation, the lighting assembly 8 further includes reflective paper 805. The reflective paper 805 is bonded to an outer wall of the lens 804.

Specifically, the reflective paper 805 is made of a thin film material having a light reflection function, for example, made of an aluminized polyester thin film or a metalized PET material, has its surface embossed to enhance the diffuse reflection effect, and is configured, in the lighting assembly 8, to redirect the light scattered inside the lens 804 to a target area. The reflective paper 805 is bonded to the outer wall of the lens 804, and the reflective paper 805 reflects the light emitted by the light source board 803, so as to improve the brightness and lumen of the lamp.

The foregoing descriptions are only specific implementations of the present disclosure. It can be clearly understood by those skilled in the art that, for convenience and brevity of description, for the specific operation processes of the systems, modules and units described above, reference can be made to the corresponding processes in the foregoing method embodiments, which will not be repeated herein. It should be understood that the scope of protection of the present disclosure is not limited herein. Any equivalent modification or replacement readily figured out by those skilled in the art within the technical scope disclosed in the present disclosure shall fall within the scope of protection of the present disclosure

What is claimed is:

1. A downlight having a spring-loaded quick-release structure, the downlight comprising a spring-loaded quick-release structure, a snap ring, and a lighting assembly, wherein the spring-loaded quick-release structure comprises:
an outer ring provided with an annular track on an inner wall of the outer ring; and
an inner ring detachably disposed within the outer ring, wherein the inner ring is formed with at least one mounting hole, and a limiting assembly is provided within the mounting hole;
and the limiting assembly comprises a sleeve, a spring, and a positioning member, the sleeve being disposed within the mounting hole, one end of the sleeve being formed with an opening, the spring being disposed within the sleeve, one end of the spring being connected to the other end of the sleeve, the other end of the spring being connected to one end of the positioning member, and the other end of the positioning member being capable of protruding from the opening of the sleeve;
wherein when the outer ring and the inner ring are assembled, the other end of the positioning member on the sleeve abuts against the annular track; when a pulling force is applied to separate the inner ring from the outer ring, the positioning member is pressed radially inward against a biasing force of the spring and disengages from the annular track; and
the lighting assembly, the snap ring, the inner ring, and the outer ring are sequentially nested and mounted from inside to outside.

2. The downlight according to claim 1, wherein a plurality of mounting holes are evenly distributed in a circumferential direction of the inner ring.

3. The downlight according to claim 1, wherein the positioning member is spherical in shape, and when the outer ring and the inner ring are assembled, the positioning member is slidable within the annular track.

4. The downlight according to claim 3, wherein a diameter of the positioning member is not greater than a diameter of the opening of the sleeve.

5. The downlight according to claim 1, further comprising a fixing member and a middle ring, wherein the inner ring is formed with a first through hole, the middle ring is formed with a second through hole that matches the first through hole, and the fixing member is capable of being inserted into the first through hole and the second through hole to enable the inner ring and the middle ring to be fixedly mounted.

6. The downlight according to claim 1, wherein at least one mounting member is provided on the outer ring, the mounting member being configured to enable installation of the downlight.

7. The downlight according to claim 1, wherein the lighting assembly comprises a heat sink, a lamp cup, a light source board, and a lens, the lamp cup being mounted at a lower end of the heat sink, the light source board being disposed within the lamp cup, and the lens being located at a front end of the light source board.

8. The downlight according to claim 7, wherein the lighting assembly further comprises reflective paper bonded to an outer wall of the lens.

9. The downlight according to claim 5, wherein the snap ring is annular, is configured to fix the lighting assembly, and is provided with an elastic snap-fit fastener that snaps into the middle ring.

10. The downlight according to claim 9, wherein a plurality of elastic snap-fit fasteners are provided and have different heights.
